(19) United States
(12) Patent Application Publication
(10) Pub. No.: US 2012/0193972 A1
(43) Pub. Date: Aug. 2, 2012

(54) BEARING POSITIONING DEVICE FOR HUB ASSEMBLY

(75) Inventor: PI-YUN CHIANG, TAICHUNG HSIEN (TW)

(73) Assignee: JOY INDUSTRIAL CO., LTD., TAICHUNG HSIEN (TW)

(21) Appl. No.: 13/246,240

(22) Filed: Sep. 27, 2011

(30) Foreign Application Priority Data
Jan. 31, 2011 (TW) 100202159

(51) Int. Cl. B60B 27/00; F16C 19/08

(52) U.S. Cl. 301/110

(57) ABSTRACT

A bearing positioning device for hub assembly includes a hub with a sleeve connected thereto, and an axle extends through the hub and the sleeve. A ratchet part extends from the sleeve and the sleeve has an engaging hole through which the axle extends. An inner bearing is mounted to an inner ring of the axle. A contact unit has at least one contact member which is mounted to the axle and has a flange whose diameter is larger than the inner diameter of the engaging hole. A contact surface is formed on one side of the at least one contact member and contacts on a side of the inner ring. The engaging hole is reduced so that the thickness of the sleeve is not reduced so as to reduce the wearing of the tools and the machining time required.

### FIELD OF THE INVENTION

The present invention relates to a positioning device, and more particularly, to a bearing positioning device for hub assembly.

### BACKGROUND OF THE INVENTION

A conventional hub assembly is connected to the center of the wheel and an axle rotatably extends through the hub, the axle is connected with the bicycle frame. Multiple spokes are connected between the flanges on the hub and the rim of the wheel.

In order to allow the wheel to rotate smoothly, a bearing is located between the axle and the hub and the bearing can be a bearing with standard inner and outer cages, and beads are located therebetween, or a bearing including a pair of bowl like races and beads are located between the races.

Taiwan Utility model No. 098209691 discloses a hub assembly which includes both of the bearings mentioned.

The bearing with inner and outer cages bears load in both axial and radial directions to allow the axle to rotate relative to the hub. The bearing can be a rolling contact bearing or a journal bearing. The operation between parts of the rolling contact bearing is in the form of rolling and the journal bearing uses lubricant to cause the relative movement of the parts.

The present invention provides an improved rolling contact bearing and comprises an inner race, an outer race, a retainer and beads. When in assembling, the outer race and the inner race are respectively connected to the hub and the axle so that the hub is rotatable relative to the axle by the beads.

When cooperated with a ratchet unit which is located between the hub and the sleeve, and the bearing is located between the inside of the sleeve and the axle. The outer race and the inner race are respectively connected to the sleeve and the axle. By the retainer between the inner and outer races and the beads, the axle and the hub have relative rotation movement.

Taiwan Utility model No. 099203257 discloses a hub assembly which includes an axle unit having an axle with two restriction members on two ends of the axle. A case mounted to the axle and a driving unit which drives the case to rotate the axle in one direction only. The driving unit has a sleeve located around the axle. A bearing unit is pivotably connected between the axle and the sleeve and includes a first bearing and a second bearing. An inner separation unit and an outer separation unit are coaxially mounted to the axle. The first and second bearings each have an inner wall and an outer wall which is rotatable relative to the inner wall, and multiple beads located between the inner and outer walls. The two ends of the inner separation unit are in contact with the inner walls of the first and second bearings, and the two ends of the outer separation u nit are in contact with the outer walls of the first and second bearings. The restriction members prevent the case form movement along the axis of the driving unit.

The bearing unit is located in the inner and outer separation units so as to respectively support the inner and outer walls of the first and second bearings so that the first and second bearings are firmly supported.

The bearing in the hub is usually cooperated with parts of the hub by contacting a washer against the inner race of the bearing. A space is formed between the hub so that the bearing is snugly engaged with the outer race of the bearing. The use of the washer and the position of the washer relate to the type of the parts and the sequence of the assembling processes.

For the sleeve and the axle, the inner race of the bearing usually mounts to the outside of the axle and is cooperated with a washer to be positioned. The outer race of the bearing is engaged with the inner periphery of the sleeve to be force-fitted. However, considering the diameter of the sleeve, which should be matched with the diameter of the axle. When the axle has a stepped outer periphery with multiple diameters, the sleeve has to be big enough to allow the maximum diameter of the axle to pass.

The diameter of the inner periphery of the sleeve affects the strength of the sleeve and the steps of the machining, the larger the diameter of the inner periphery of the sleeve, the smaller the structural strength of the sleeve will be. A large inner diameter wears the blade of the tool, requires time and energy, especially when there is a ratchet part on the back of the sleeve. There are multiple recesses and ridges on the ratchet part for being engaged with ratchet gear. The ratchet recesses affects the central hole of the ratchet part and the diameter of the axle, and the thickness of the ratchet part between recesses. Therefore, when the axle has a large outer diameter, the hole for accommodating the axle has to be large enough, if the depth of the ratchet recess is significant, the thickness of the wall between the ratchet recesses and the central hole is affected and the structural strength becomes weak.

### SUMMARY OF THE INVENTION

The present invention relates to a bearing positioning device for hub assembly and comprises a hub with an axle extending therethrough. A sleeve is connected to one end of the hub and the axle extends through the sleeve. A ratchet unit is located between the hub and the sleeve which has a ratchet part extending axially therefrom. The sleeve has an engaging hole defined centrally therein. The axle extends through the engaging hole. A rotation unit is located between the axle and the sleeve, and has an inner bearing which is mounted to an inner ring of the axle. A contact unit has at least one contact member which is mounted to the axle and has a flange whose diameter is larger than the inner diameter of the engaging hole. A contact surface is formed on one side of the at least one contact member and contacts on a side of the inner ring. The inner diameter of the engaging hole is reduced and the thickness of the sleeve is maintained so as to reduce the wearing of the tools and the machining time required.

The primary object of the present invention is to provide a bearing positioning device for hub assembly, wherein the engaging hole of the sleeve is set to meet the section of the axle that is within the sleeve so as to reduce the inner diameter of the engaging hole of the sleeve.

Another object of the present invention is to provide a bearing positioning device for hub assembly, wherein the reduced diameter of the engaging hole of the sleeve reinforces the structural strength of the sleeve such that the wearing of the tools and the machining time required are both reduced.

Yet another object of the present invention is to provide a bearing positioning device for hub assembly, wherein the contact member is maintained its larger diameter to fully contact the inner ring to provide better positioning feature.

Yet another object of the present invention is to provide a bearing positioning device for hub assembly, wherein the recesses of the ratchet part and the guide slots are located alternatively to each other so that the outer diameter of the ratchet part needs not to be increased and the thickness of the sleeve is maintained. The structural strength of the sleeve is maintained.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bearing positioning device of the present invention;

FIG. 2 is an exploded view to show the bearing positioning device of the present invention;

FIG. 3 is cross sectional view of the bearing positioning device of the present invention;

FIG. 4 is an end cross sectional view of the bearing positioning device of the present invention;

FIG. 5 is an enlarged partial view of the bearing positioning device of the present invention;

FIG. 6 is an exploded view to show the second embodiment of the bearing positioning device of the present invention;

FIG. 7 is an exploded view to show the third embodiment of the bearing positioning device of the present invention;

FIG. 8 is an exploded view to show the third embodiment of the bearing positioning device of the present invention;

FIG. 9 is a cross sectional view of the bearing positioning device of the present invention;

FIG. 10 is an exploded view to show yet another embodiment of the bearing positioning device of the present invention;

FIG. 11 is a cross sectional view of another embodiment of the bearing positioning device of the present invention, and

FIG. 12 is an exploded view to show yet another embodiment of the bearing positioning device of the present invention.

### DETAILED DESCRIPTION OF THE PREFERRED EMBODIMENT

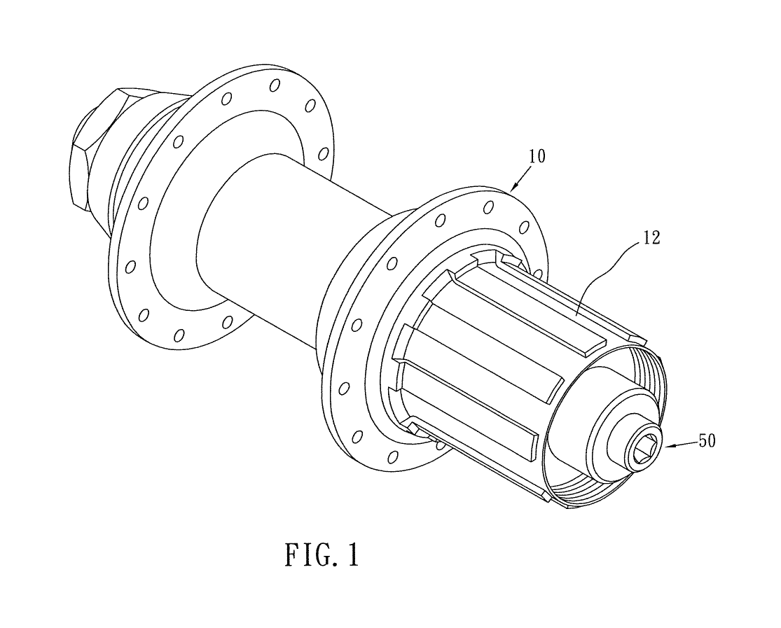

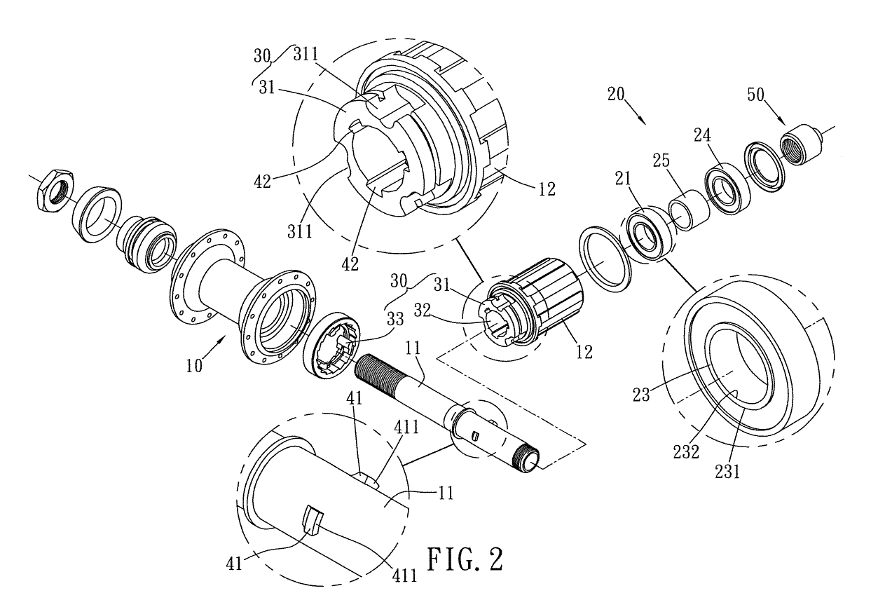

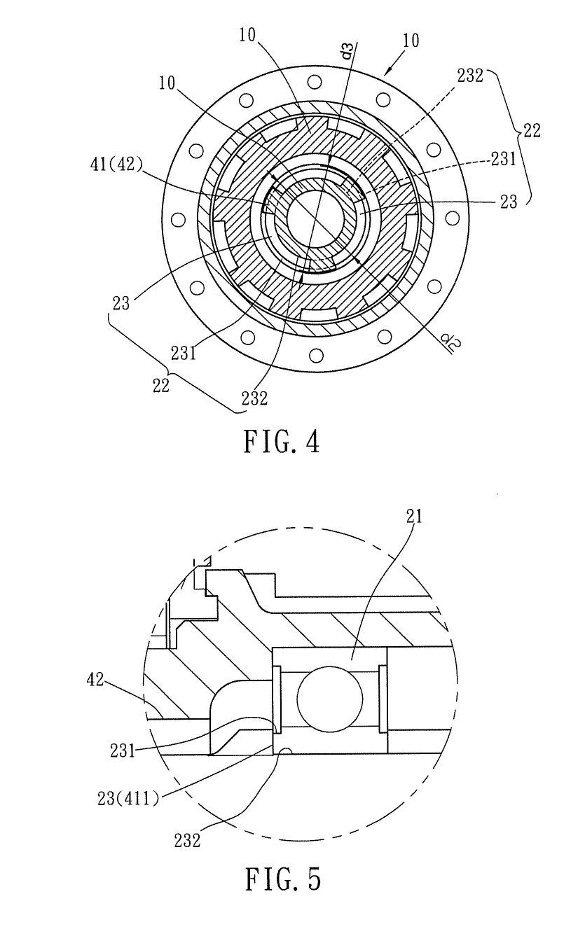

Referring to FIGS. 1 to 5, the bearing positioning device of the present invention comprises a hub 10, a rotation unit 20 located in the hub 10, a ratchet unit 21 and a contact unit 22.

An axle 11 extends through a central axis of the hub 10 and a sleeve 12 is connected to an end of the hub 10. The axle 11 extends through the sleeve 12.

The rotation unit 20 is located between the axle 11 and the sleeve 12 so that the sleeve 12 is smoothly rotated about the axle 11. The rotation unit 20 has an inner bearing 21 and an outer bearing 24, and a contact ring 25 is located between the inner and outer bearings 21, 24. The inner ring 21 has an inner ring 22 which is mounted to the axle 11. The inner ring 22 is composed of an outer portion 231 and an inner portion 232 which shares a common center with the outer portion 231. The outer portion 231 and the inner portion 232 define a contact face 23.

The ratchet unit 30 is located between the hub 10 and the sleeve 12, so that the hub 10 and the sleeve 12 are operated in one direction only. The ratchet unit 30 has a ratchet part 31 extending axially from the sleeve 12 and has an engaging hole 32 defined centrally therein. The axle 11 extends through the engaging hole 32. The inner diameter of the engaging hole 32 is smaller than the outer portion 231. The ratchet part 31 has three recesses 311 defined therein and three pawls 33 are engaged with the recesses 311.

The contact unit 40 is located between the axle 11 and the rotation unit 20. The contact unit 40 has three contact members 41 which are in the form of three flanges extending radially from the outer periphery of the contact unit 40. The diameter of each contact member 41 is larger than the inner diameter of the engaging hole 32. A contact surface 411 is formed on a side of each of the contact members 41 and contacts against the inner ring 22.

The contact unit 40 has three contact members 41 and three guide slots 42 which are cooperated with the contact members 41 in pairs. The contact members 41 each are a rectangular block protruding from the axle 11 and are located about the axis of the axle 11. The guide slots 42 each are a rectangular recess and defined radially in the inner periphery of the engaging hole 32. The number of the contact members 41 is the same as the number of the engaging holes 32. The contact members 41 are sized to pass through the guide slots 42, and the contact surface 411 contacts on a side of the inner ring 22 after the contact members 41 pass through the guide slots 42. The recesses 311 are located alternatively to the guide slots 42.

The reduced diameter of the engaging hole 32 of the sleeve 12 reinforces the structural strength of the sleeve 12 such that the wearing of the tools and the machining time required are both reduced. The contact members 41 are maintained their larger diameter to fully contact the inner ring 22 to provide better positioning feature.

When in assembling, the ratchet ring of the ratchet unit 30 is installed in the hub 10 and the axle 11 extends through the hub 10 and positioned. The inner bearing 24 is installed into the sleeve 12 and the pawls 33 are engaged with the recesses 311 of the ratchet part 31. The sleeve 12 is located between the ratchet ring and the axle 11. The contact members 41 are located in alignment with the guide slots 42, and the contact members 41 pass through the guide slots 42 and the contact surfaces 411 contact the contact faces 23. The pawls 33 are respectively engaged with the ratchet ring. The contact ring 25 and the outer bearing 24 are finally connected between the sleeve 12 and the axle 11, and are positioned by using a positioning unit 50.

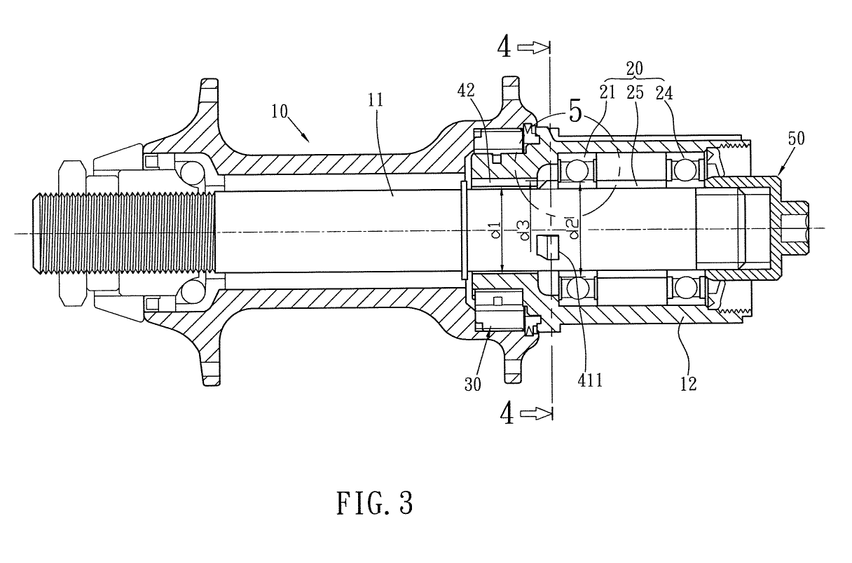

As shown in FIG. 3, the outer diameter d3 of the contact members 41 is larger than the inner diameter d1 of the engaging hole 32 so that the contact members 41 so that the contact member 41 are able to pass through the engaging hole 32. Besides, the outer diameter d3 of the contact members 41 is larger than the diameter d2 of the outer diameter portion 231 of the inner ring 22 so that the contact surfaces 411 are able to contact the contact faces 23 by larger area to provide better positioning feature.

Another embodiment is when the inner diameter of the engaging hole 32 is smaller while the thickness of the sleeve 32 between the engaging hole 32 and the recesses 311 is maintained the pre-set range, and the contact members 41 are able to pass through the engaging hole 32, and the contact members 41 evenly contact the inner ring 22.

The inner diameter d1 of the engaging hole 32 does not need to consider the outer diameter d3 of the contact members 41, as long as the section of the axle 11 that extends through the engaging hole 32 is allowed to pass. Therefore, the inner diameter of the engaging hole 32 can be reduced and thanks to the reduction, the thickness of the sleeve 12 between the recesses 311 and the engaging hole 32 is not reduced and the structural strength of the sleeve 12 is maintained. Furthermore, the material that is removed when drilling the engaging hole 32 is minimized and the life of the tool for drilling the engaging hole 32 is prolonged and the machining time required is shortened.

In order to make the contact surfaces 411 evenly contact the contact faces 23, the number of the contact members 41 is three which are located evenly spaced, and the outer diameter d3 of the contact members 41 is larger than the outer diameter d2 of the inner ring 22, such that the inner ring 22 is well positioned.

The outer diameter d3 of the contact members 41 is larger than the inner diameter d1 of the engaging hole 32 and the outer diameter d2 of the outer portion 231 of the inner ring 22, and the guide slots 42 are sized to allow the contact members 41 to pass. There are two advantages of the specific arrangement, one of which is that the sleeve 12 does not mount to the axle 11 off the center so that the inner bearing 21 in the sleeve 12 is not pushed to be shifted from its correct position. The second advantage is that the guide slots 42 and the recesses 311 are located alternatively to each other, so that the thickness of the sleeve 12 is maintained to keep the structural strength of the sleeve 12.

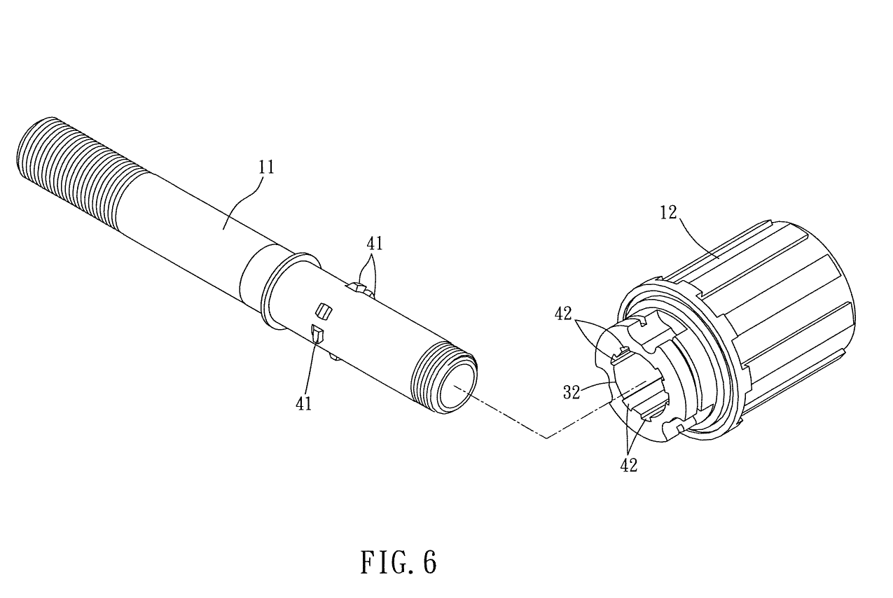

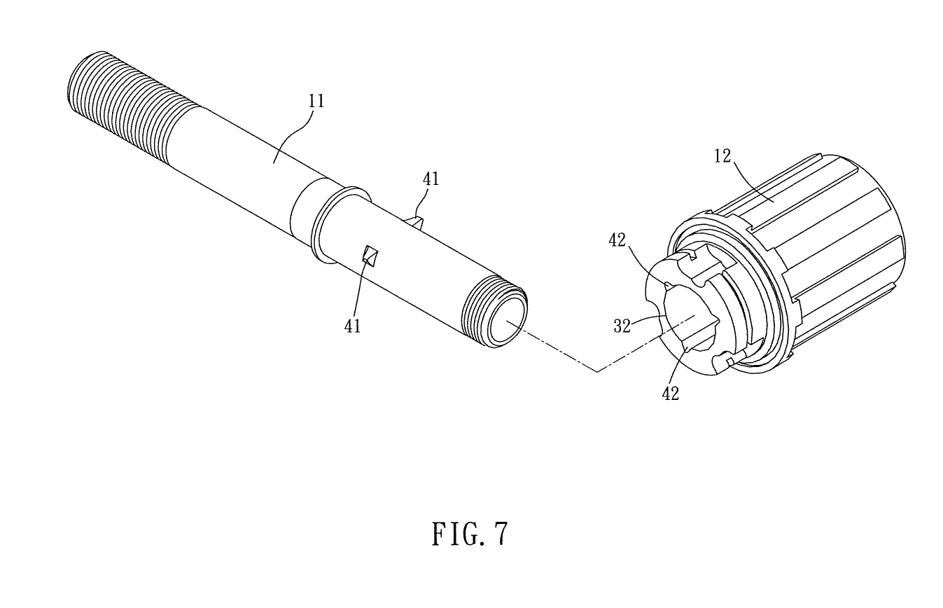

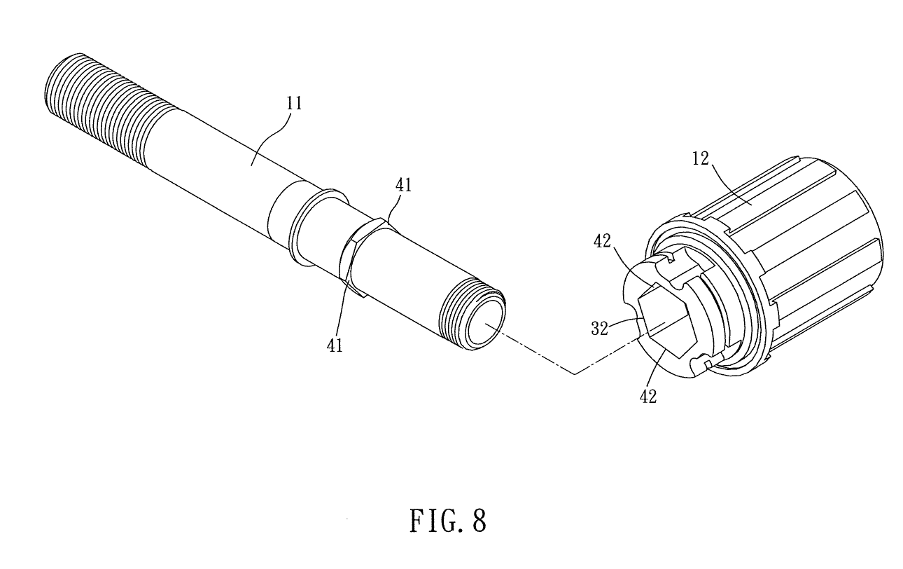

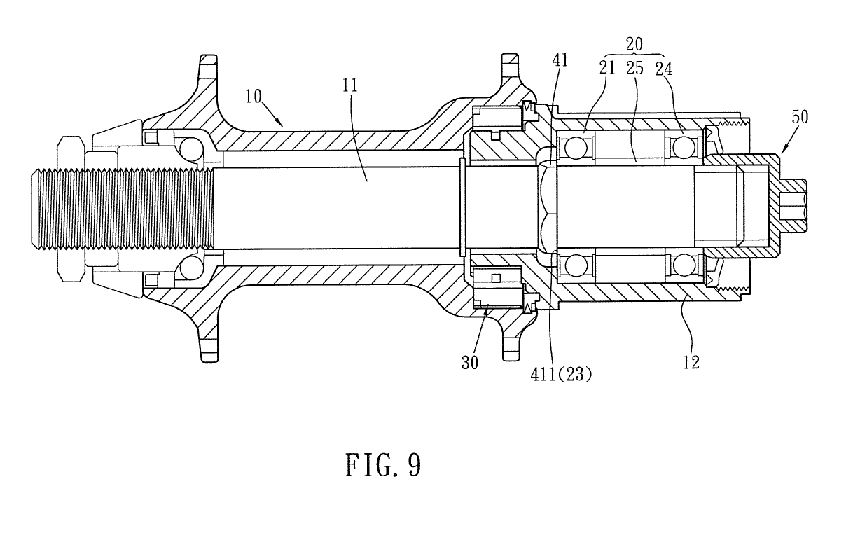

As shown in FIGS. 6 to 8, the contact members 41 are located in pairs and three pairs of the contact members 41 are equally spaced located on the outer periphery of the axle 11. The guide slots 42 are arranged corresponding to the contact members 41 as shown in FIG. 6. FIG. 7 shows that the contact members 41 each have three sides and the cooperated guide slots 42 are a space with three insides so as to accommodate the contact member 41. FIGS. 8 and 9 show that the contact members 41 each are a hexagonal block and the guide slots 42 are cooperated with the engaging hole 32 to form a space with hexagonal inside.

These embodiments disclose that the shape of the contact members 41 are geometric protrusions and formed on the axle 11 by preset number and distance between any two contact members 41. The guide slots 42 are correspondingly arranged to obtain desired function.

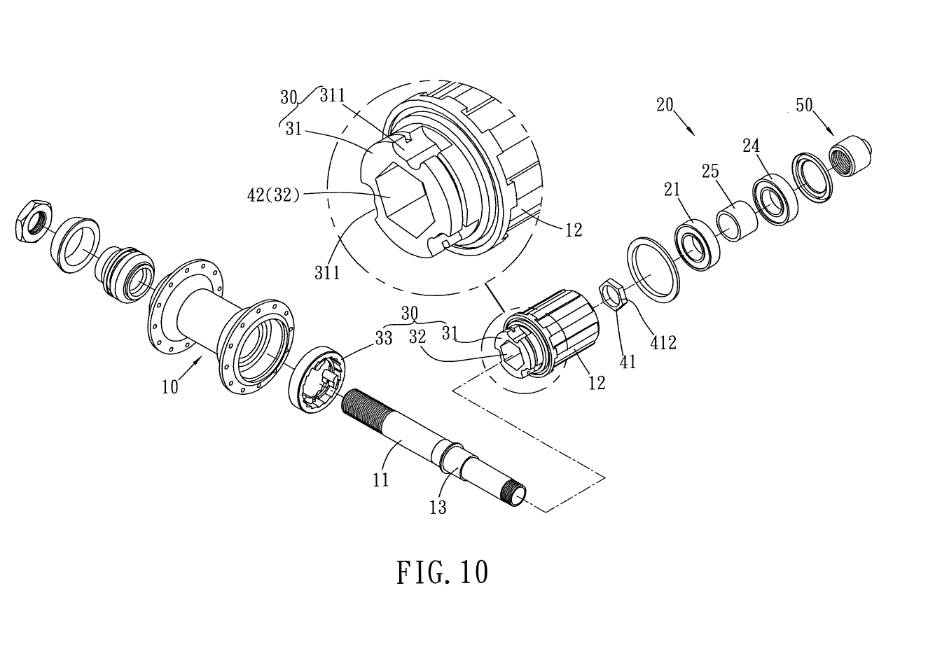

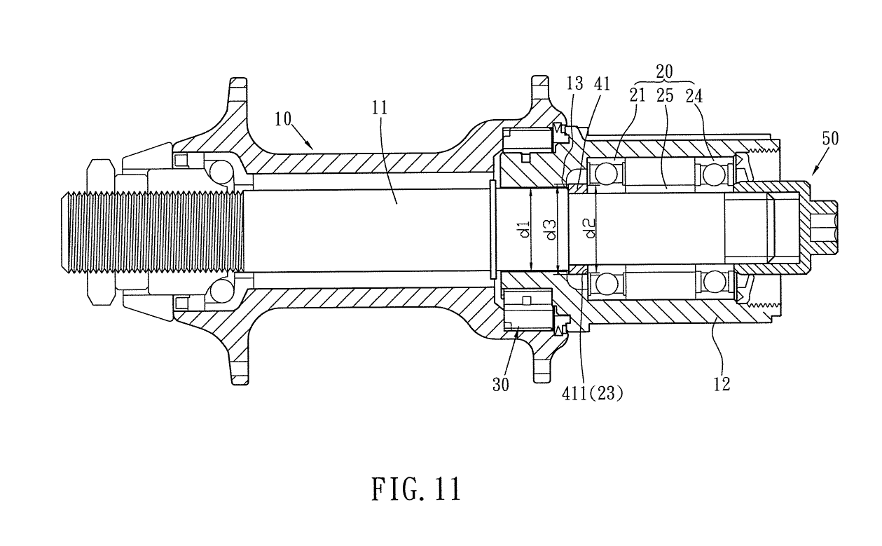

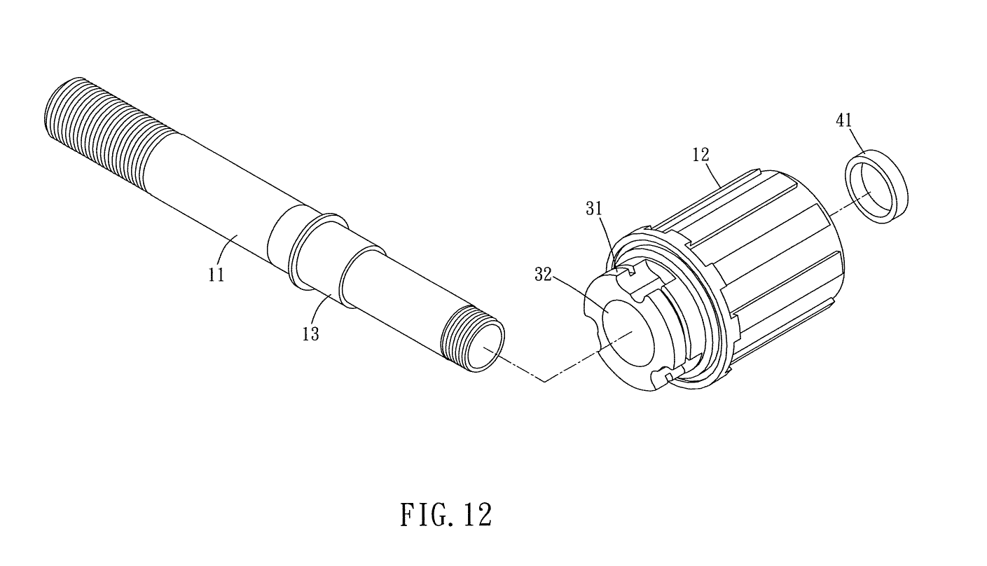

FIGS. 10 and 11 show that the axle 11 includes a stepped stop 13 with larger outer diameter so that the contact member 41 can be stopped by the stepped stop 13. The contact member 41 is a hexagonal flange and a through hole 412 is defined centrally through the flange so that the axle 11 extends through the through hole 412. The contact member 41 and the axle 11 are two separated parts. The engaging hole 32 does not have any guide slot 42 defined therein.

When assembling, the ratchet ring of the ratchet unit 30 is installed in the hub 10 and the axle 11 extends through the hub 10. The pawls 33 are engaged with the recesses 32, and the sleeve 12 is located between the axle 11 and the ratchet ring, and the pawls 33 are engaged with the ratchet ring. The contact members 41, the inner bearing 21, the contact ring 25 and the outer bearing 24 are located between the sleeve 12 and the axle 11, and are positioned by a positioning unit 50.

The embodiment uses the separate contact member 41 whose outer diameter d3 is larger than the inner diameter d1 of the engaging hole 32 and the outer diameter d2 of the outer portion 231 of the inner ring 22, so that the contact surface 411 contacts the contact face 23. There will be no guide slot 42. The sleeve 12, the contact member 41, the inner bearing 21, the outer bearing 24 and the contact ring 25 are installed in sequence which is slightly different from that of the above-mentioned embodiments, and the function is the same. Besides, the contact surface 411 and the contact face 23 are fully in contact with each other and this is better than that of the above-mentioned embodiments.

The shape of the contact member 41 can be varied, as disclosed in FIG. 12, the contact member 41 has a circular outer periphery and achieves the same function.

While we have shown and described the embodiment in accordance with the present invention, it should be clear to those skilled in the art that further embodiments may be made without departing from the scope of the present invention.

What is claimed is:

1. A bearing positioning device for hub assembly, comprising:
a hub and an axle extending through a central axis of the hub, a sleeve connected to an end of the hub and the axle extending through the sleeve;
a rotation unit located between the axle and the sleeve, the rotation unit having an inner bearing which has an inner ring mounted to the axle;
a ratchet unit located between the hub and the sleeve, so that the hub and the sleeve are operated in one direction only, the ratchet unit having a ratchet part extending axially from the sleeve and having an engaging hole defined centrally therein, the axle extending through the engaging hole, and
a contact unit located between the axle and the rotation unit, the contact unit having at least one contact member and at least one guide slot, the at least one contact member connected to the axle and being a flange whose diameter is larger than an inner diameter of the engaging hole, a contact surface being formed on a side of the at least one contact member, the at least one guide slot radially defined in an inner periphery of the engaging hole and the at least one contact member being sized to pass through the at least one guide slot, the contact surface contacting on a side of the inner ring after the at least one contact member passes through the at least one guide slot.

2. The device as claimed in claim 1, wherein the at least one contact member is mounted to the axle and located about an axis of the axle, the at least one guide slot is located on an inner periphery of the engaging hole, a number of the at least one contact member is the same as the number of the engaging hole.

3. The device as claimed in claim 1, wherein the at least one contact member is integrally formed on the axle.

4. The device as claimed in claim 1, wherein the at least one contact member is a protrusion of geometric shape and the at least one guide slot is complementarily engaged with the contact member.

5. The device as claimed in claim 1, wherein multiple recesses are defined in an outer periphery of the ratchet part and the recesses are located alternatively to the at least one guide slot.

6. A bearing positioning device for hub assembly, comprising:
a hub and an axle extending through a central axis of the hub, a sleeve connected to an end of the hub and the axle extending through the sleeve;
a rotation unit located between the axle and the sleeve, the rotation unit having an inner bearing which has an inner ring mounted to the axle;
a ratchet unit located between the hub and the sleeve so that the hub and the sleeve are operated in one direction only, the ratchet unit having a ratchet part extending axially from the sleeve and having an engaging hole defined centrally therein, the axle extending through the engaging hole, and
a contact unit located between the axle and the rotation unit, the contact unit having a contact member which is connected to the axle and has a flange whose diameter is larger than an inner diameter of the engaging hole, a contact surface being formed on a side of the contact member, the contact surface contacting on a side of the inner ring.

7. The device as claimed in claim 6, wherein the contact member is a protrusion of geometric shape.

8. The device as claimed in claim 1, wherein the contact member and the axle are two separated parts.
